(19) United States
(12) Patent Application Publication
(10) Pub. No.: US 2025/0181425 A1
(43) Pub. Date: Jun. 5, 2025

(54) Dynamically Generating Content via GUI-Programmable Input Devices and API Calls

(71) Applicant: Justin S. Diamond, South Setauket, NY (US)

(72) Inventor: Justin S. Diamond, South Setauket, NY (US)

(21) Appl. No.: 18/527,432

(22) Filed: Dec. 4, 2023

(51) Int. Cl. G06F 9/54; G06F 3/038; G06F 3/04845; G06F 3/04847; G06F 9/451; H04L 9/32

(52) U.S. Cl. CPC G06F 9/543; G06F 3/038; G06F 3/04845; G06F 3/04847; G06F 9/451; H04L 9/32

(57) ABSTRACT

Disclosed is a novel method for (1) programming input devices to execute configurable API calls in a Graphical User Interface (GUI), and (2) using text-selection, hotkeys, and user-configured prompts/parameters to execute dynamic API calls and generate content in real-time. The GUI in method (1) allows users to store API & authentication keys, access various content generation/AI models, configure custom prompts, assign prompts to hotkeys/activation methods, and otherwise control the methods by which their input device rapidly executes custom API calls and dynamically generates content. The process in method (2) allows users to generate text, image, or other multimedia content through API-accessible platforms, then print, display, and/or save the output without having to open other applications. When combined, these methods enable users to flexibly control and access content generation platforms and generative AI models from almost any application at the press of a button.

### FIELD OF INVENTION

The present invention relates to dynamic content generation. More particularly, using GUI-programmable input devices to execute configurable API calls and dynamically generate multimedia content in real-time.

### BACKGROUND

The growing popularity of generative artificial intelligence (AI) and other forms of content generation has been facilitated by users' ability to easily access different platforms through applications on the web. The benefit of accessing these tools through the web is that no programming or tech-savviness is required. However, there are also drawbacks associated with using web apps in their native environment. For example, if the web app is not left open then the user has to launch it every time they want to use it, and when the user wants to input text from another tab or app, they must manually copy and paste it while migrating between apps. Additionally, most platforms don't allow users to save commonly used prompts or preset their favorite prompt parameters, so users must type in the same prompts over and over again—be it “Write me a 1 page summary of [this]” or “Draw a painting of [that] in the style of John Singer Sargent.”

There exist methods and solutions for some of these problems, but they are either implemented on an app-by-app basis through “plug-ins,” or are incredibly difficult for users to set up and configure. For example, prior patents have disclosed the method of programming input devices to launch executable files by activating a hotkey, but none have described—as is disclosed herein—how API calls to content generation platforms can be made easily configurable inside of a GUI.

This product is useful beyond existing products because it allows the API call that is executed by the user input device to be configured in the same GUI as the user input device. This means that within the GUI, users can easily modify the prompts, parameters, services, access keys, text-selection methods, and content output methods being used to create and execute API calls. It is also useful insofar as the method of combining text-selection, hotkeys, and user-configured prompts/parameters to create and execute API calls will allow users to generate content in real-time without having to rely on plug-ins, launch new applications, switch between tabs, re-enter prompts, or otherwise waste time when doing ordinary tasks. Finally, it renders the user capable of turning text into summaries, paintings, poems, translations, computer programs, essays, videos, audio files, spreadsheets, or any other multimedia content available through API-accessible content generation platforms.

No prior invention maximizes both the ease of prompt/API call configuration and the speed of content generation to this extent. Accordingly, the methods disclosed herein enable users to flexibly control and access generative models from almost any application at the press of a button.

### BRIEF SUMMARY OF INVENTION

The present invention comprises a novel improvement upon (1) GUI-programmable user input devices, and (2) dynamic content generation via API calls is disclosed, wherein the user input devices can be programmed to create and execute API calls that are configurable within the same GUI as the user input device, and the method of generating content is comprised of text-selection, hotkey activation, API key, text, and prompt retrieval, API execution, and content output/display. The method of generating content also interfaces with storage, network, server, application, and other elements as necessary for content completion and delivery. The user also has the ability to create multiple user profiles on various devices, and can store/access unique sets of instructions, configurations, and prompts on each profile or device.

The above summary of the present invention is not intended to represent each embodiment, or every aspect, of the present invention. The detailed description and figures will describe many of the embodiments and aspects of the present invention.

### BRIEF DESCRIPTION OF THE DRAWINGS

Some embodiments of the present invention are illustrated as an example and are not limited by the figures of the accompanying drawings, in which like references may indicate similar elements.

FIG. 1 depicts a Graphical User Interface (GUI) in which there is a navigation bar, a “Devices” tab, a “Profiles” tab, a “Button Assignment” tab, and a “Configuration” tab. In the “Configuration” tab, API calls can be configured by (1) selecting a content generation platform to make API calls to, (2) customizing text-based prompts, and (3) selecting a content output method. Additionally, this tab could include options to modify parameters that are specific to the selected platform's API. These configurable API calls can also be attributed to hotkeys or other activation methods on the user input device in the “Button Assignment” tab, which in this embodiment displays a programmable mouse.

FIG. 2 depicts a Graphical User Interface (GUI) in which API keys, or other secret access keys, can be entered and securely stored.

FIG. 3 illustrates the process of text selection in a web browser, two different hotkey activations, the execution of each hotkey's respective user-configured API call, and the resulting outputs.

FIG. 4 displays example code that shows how API calls are ordinarily used to generate and display outputs in a window. An actual implementation of the method claimed would use the custom prompt from FIG. 1, the API key from FIG. 2, and the selected text from FIG. 3 as GUI-configurable variables that are securely stored, whereas in this example the text is “hard-coded” in for illustrative purposes.

FIG. 5 depicts the claimed method for creating and executing an API call that has been configured in the GUI upon text selection and hotkey activation. It shows the interaction of all necessary components, and the order in which they operate to generate content. It also contains indications for which components of the method require user actions or inputs, and which are automatically processed or executed.

### DETAILED DESCRIPTION OF THE INVENTION

The terminology used herein is for the purpose of describing the particular embodiments only and is not intended to be limiting of the invention. As used herein, the term “and/or” includes any and all combinations of one or more of the associated listed items. As used herein, the singular forms “a,” an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

IN describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invitation. It will be evident, however, to one skilled in the art that the present invention may be practiced without these specific details.

The present disclosure is to be considered as an exemplification of the invention, and is not intended to limit the invention to the specific embodiments illustrated by the figures attached or description below.

A novel method for (1) programming input devices to execute configurable API calls in a Graphical User Interface (GUI), and (2) using text-selection, hotkeys, and user-configured prompts/parameters to execute dynamic API calls and generate content in real-time is disclosed herein. The GUI in method (1) allows users to store API & authentication keys, access various content generation/AI models, configure custom prompts, assign prompts to hotkeys/activation methods, and otherwise control the methods by which their input device rapidly executes custom API calls and dynamically generates content. The process in method (2) allows users to generate text, image, or other multimedia content through API-accessible platforms, then print, display, and/or save the output without having to open other applications. When combined, these methods enable users to flexibly control and access generative models from almost any application at the press of a button.

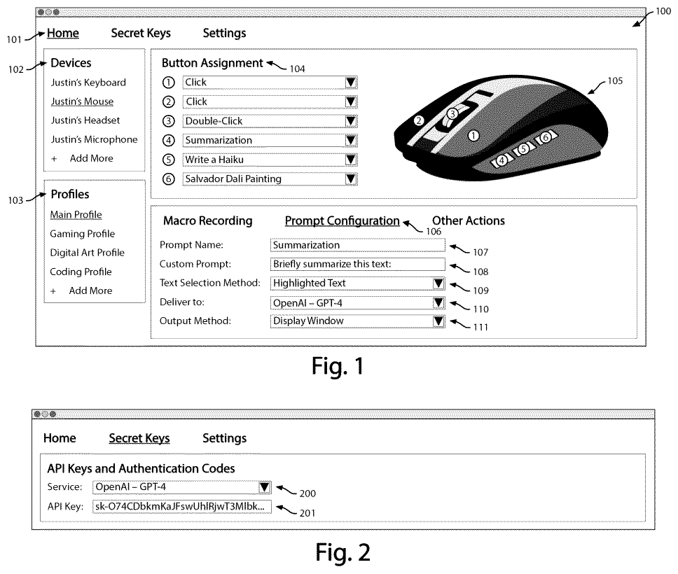

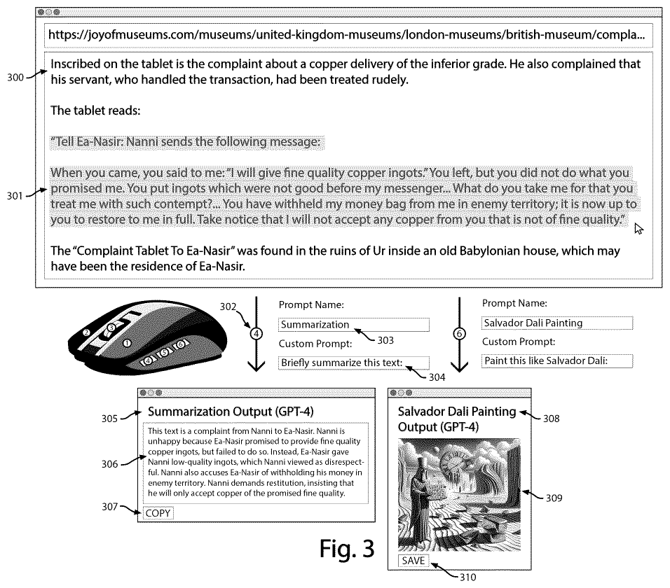

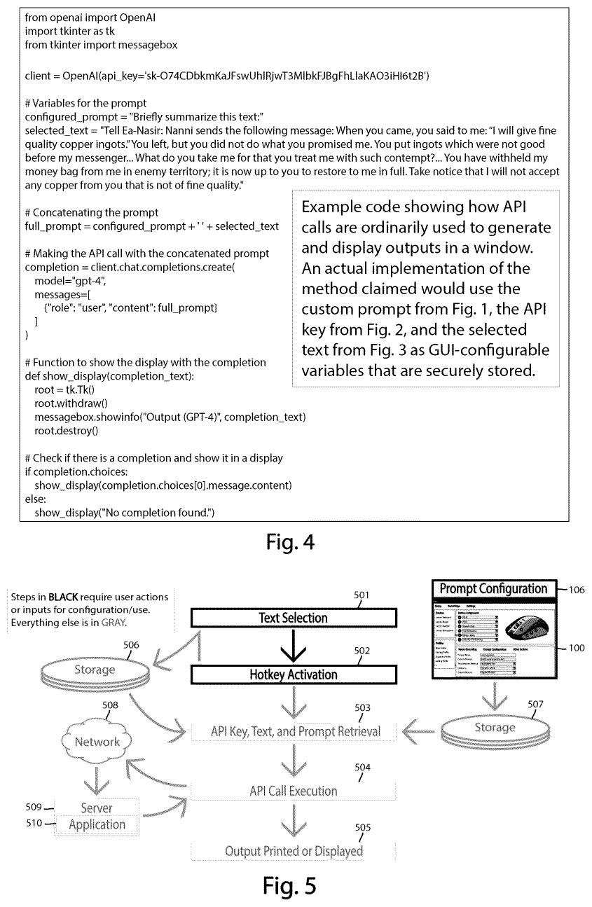

This invention can be described by referencing the appended figures, which represent preferred embodiments: FIG. 1 depicts a Graphical User Interface (GUI) 100 in which there is a navigation bar 101, a “Devices” tab 102, a “Profiles” tab 103, a “Button Assignment” tab 104, a display of the selected user input device 105, and a “Configuration” tab 106. In this embodiment, the user input device is a programmable mouse with input buttons labeled 1-6 105. However, keyboards, headsets, touchscreens, controllers, microphones, cameras, and other such programmable input devices could all conceivably be implemented as part of the method disclosed herein.

As with other tabs, the elements of the “Configuration” tab are not limited to those illustrated in this figure. Depending on the service selected in drop-down menu 110, different prompt-related parameters could appear, and be reconfigured by the user; parameters ordinarily used when prompting generative AI models, such as “Temperature” or “Maximum length” may also be included in the configuration tab 106. In “Configuration” tab 106, API calls can be configured via text box, dropdown menu, or similar widget. The configurations in this embodiment allow users to (1) name their prompt configuration 107, (2) customize text-based prompts 108, (3) choose a method of text-selection 109 for the block of text that will follow the user's custom prompt 108, (4) select a content generation platform to make API calls to 110, and (5) select a content output method 111. Additionally, this tab could include options to modify parameters that are specific to the selected platform's API. These configurable API calls can also be attributed to hotkeys or other activation methods on the user input device in the “Button Assignment” tab, which in this embodiment displays a programmable mouse. Note that in this embodiment, 108 being left empty would mean that the text selected by 109 would constitute the entire prompt, since the custom prompt and the text selected are concatenated per FIG. 4.

Text selection methods in the 109 dropdown menu can comprise a selection of text that is (1) highlighted on the screen per FIG. 3., 301, (2) input manually upon hotkey activation, (3) extracted by a context-based feature capable of automatically identifying and selecting the most relevant text on-screen, or (4) obtained by some other method. It is also possible that images or other forms of multimedia content can be used as inputs to content generation platforms, though such implementations are not illustrated herein. Output methods in the 111 dropdown menu can print, display, copy, save, archive, or otherwise transmit the generated content upon its completion.

Disclosed in FIG. 2 is a page where users can input API or other authentication keys for accessible services. This comprises a way to select a service 200 and a place to input/store an access key for that service 201.

FIG. 3 illustrates the process of text selection, which in this embodiment occurs in a web browser. When viewing any body of text 300, the most basic text selection method 109 is to simply highlighted the text, which in this case is represented by 301. In this illustration, after the text has been highlighted 301, hotkey number 4 on the user input device 105 is activated 302. The prompt and prompt name assigned to this hotkey are also shown 304, 303. These are the same prompt configurations as seen in the “Configuration” tab of FIG. 1, 106. In this particular configuration, the resulting output can be viewed in a display window 305 which contains text 306 and a copy button 307. Also displayed in a window 308 are the outputs of hotkey number 6, which in this embodiment has been configured to generate an image 309 from the text-based input. This image can be saved by pressing a button 310 which is contained in the display window 308. Again, it is worth noting that outputs like 306 and 309 can be output in various ways, such as by being printed directly in an app. Also, various buttons, such as share buttons, can accompany the copy 307 or save 310 button, despite not being displayed in FIG. 3.

The method, as illustrated in FIG. 3, was configured to generate an API call that prompted the content generation platform to first “Briefly summarize this text: ” 304, 305, 306, then to “Paint this like Salvador Dali:” 308, 309, in reference to 301. There is practically no limit to the number of custom prompts that a user could enter into 108, and this method could be used to turn text or other multimedia content into summaries, paintings, poems, translations, computer programs, essays, videos, audio files, spreadsheets, or any other format available through API-accessible content generation platforms.

FIG. 4 displays example code that shows how API calls are ordinarily used to generate and display outputs in a window. An actual implementation of the method claimed would use the custom prompt from FIG. 1, the API key from FIG. 2, and the selected text from FIG. 3 as GUI-configurable variables that are securely stored, whereas in this example the text is “hard-coded” in for illustrative purposes.

FIG. 5 depicts the claimed method for creating and executing an API call that has been configured in the GUI 100, 106 upon text selection 501 and hotkey activation 502. It shows the interaction of all necessary components, and the order in which they operate to generate content. At its core, the process flows from text-selection 501 to hotkey activation 502 to API key, text, and prompt retrieval 503 to API call execution 504 to the output bring printed or displayed 505. Also illustrated are peripheral components, such as storage methods 506, 507, a network 508, a server 509, and an application contained in that server 509.

With regard to storage 506, 507; portions of the methods described, and their various components or configurations may be stored as software code, text, or other files within ROM, RAM, HD, SSD, Cloud Storage, EEPROM, NVRAM, “Clipboards,” or other appropriate data processing systems, readable mediums, or storage devices. These systems may permanently or temporarily store keys 201, configurations 106, variables, text blocks, or other elements for the purposes of successfully executing the methods disclosed herein.

Additionally, any suitable programming language can be used to implement the routines, methods or programs of embodiments of the invention described herein, including Python, C, C++, Java, JavaScript, HTML, or any other programming or scripting code. A wide range of software/hardware/network architectures may be used.

1. A method for programming input devices to execute configurable API calls in a Graphical User Interface (GUI) comprising:
a programmable user input device; and
a navigable software application that allows users to:
create multiple user profiles;
program and configure multiple devices;
input API & authentication keys to access various platforms;
configure custom prompts/API calls; and
program the user input device to execute user-configured prompts, ordinary macros, or other actions; and
a memory for storing user profiles, devices, API & authentication keys, user-defined programming instructions and prompt/API call configurations.

2. The method of claim 1, wherein the programmable user input device can be programmed to execute certain recorded macros, user-configured API calls, or other actions when triggered via assigned hotkeys or other activation methods.

3. The method of claim 1, wherein the programmable user input device includes one or more of the following: a mouse, a keyboard, a headset, a touchscreen, a controller, a microphone, or a camera.

4. The method of claim 1, wherein the GUI/software application allows for the customization of both its user interface and connected user input devices, including but not limited to theme, layout, lighting, and accessibility option customization.

5. The method of claim 1, wherein user profiles and device configurations can be exported, shared, and transferred between different users—either directly or via cloud storage.

6. The method of claim 1, wherein portions of the methods described, including their various components and configurations, are stored as software code, text, or other files within ROM, RAM, HD, SSD, Cloud, EEPROM, NVRAM, and/or a clipboard.

7. The method of claim 1, further comprising security measures for storing and handling API & authentication keys, including encryption and user authentication protocols to prevent unauthorized access.

8. The method of claim 1, wherein the user-configured prompts and macros can include conditional logic, allowing for complex command sequences based on specific user-defined conditions.

9. The method of claim 1, wherein the software application provides real-time feedback during the programming and configuration process, including prompt suggestions, error checking, and parameter optimization.

10. The method of claim 1, wherein the software application allows users to configure any parameters that are adjustable through the API of the content generation platform being accessed.

11. The method of claim 1, wherein the software application includes settings for optimizing API call efficiency and controlling API usage, including but not limited to batching requests, reducing data transfer, and managing API call limits.

12. A method for using text-selection, hotkeys, and user-configured prompts/parameters to create and execute dynamic API calls and generate content in real-time comprising:
text-selection, wherein a text block is highlighted, extracted, copied, or otherwise obtained for storage and use; and
hotkey-activation, wherein a button is pressed on the user input device which triggers the creation and execution of a dynamic API call; and
retrieval of the API key, selected-text, and user-configured prompt, wherein these elements are retrieved from storage and used to formulate a custom API call; and
API call execution, wherein content is generated through some API-accessible platform; and
output, wherein the completion of the API call produces dynamically generated content that can be printed, displayed, copied, saved, archived, or otherwise transmitted to the user; and
a memory for storing code, text, or other files and executables required for each step of the overall method.

13. The method of claim 12, further comprising a text-selection feature, wherein any text on-screen can be selected by highlighting it via click and drag, and leaving it highlighted during hotkey activation.

14. The method of claim 12, further comprising a contextual text-selection feature, wherein the text-selection mechanism is capable of automatically identifying and selecting text from the user's screen, based on criteria such as keywords, phrases, formatting styles, or location within a document, webpage, or application.

15. The method of claim 12, further comprising a text-selection feature, wherein the custom prompt text can customized in real-time outside of the GUI, in one embodiment by allowing the user to input a new prompt upon each instance of hotkey activation.

16. The method of claim 12, wherein portions of the methods described, including their various components and configurations, are stored as software code, text, or other files within ROM, RAM, HD, SSD, Cloud, EEPROM, NVRAM, and/or a clipboard.

17. The method of claim 12, further comprising security measures for storing and handling API & authentication keys, including encryption and user authentication protocols to prevent unauthorized access.

18. The method of claim 12, wherein the software application allows users to view and save API calls, or a historic log of API calls, that were created and executed in the past.

19. The method of claim 12, further comprising a feature for receiving generated outputs in various multimedia formats, including one or more of the following: text, image, audio, video, html, pdf, spreadsheet, presentation, or other multimedia/interactive format.

20. The method of claim 12, further comprising a feature for sharing the output that was generated via email, text, social media, or other content-sharing service.
